(19) United States
(12) Patent Application Publication
(10) Pub. No.: US 2006/0154538 A1
(43) Pub. Date: Jul. 13, 2006

(54) Marine fuel supply system and a marine craft including same

(75) Inventors: Paul George McCarthy, Middlesex (GB); Michael Paul Folan, Ken t (GB)

Correspondence Address: VENABLE LLP, P.O. BOX 34385, WASHINGTON, DC, 20045-9998, US

(73) Assignee: Water-D-Tech Global Limited, Shepperton, Middlesex (GB)

(21) Appl. No.: 10/520,355

(22) PCT Filed: Jun. 25, 2003
(86) PCT No.: PCT/EP03/06706

§ 371 Date: Oct. 12, 2005

(30) Foreign Application Priority Data
Jul. 4, 2002 (GB) 0215469.8

(51) Int. Cl. F02B 61/04

(52) U.S. Cl. 440/88 F

(57) ABSTRACT

A marine fuel supply system is disclosed in which a salt water sensor is positioned between a fuel reservoir and a pump used to pump fuel from the reservoir to an internal combustion engine. The water sensor is located near to the bottom of a closed vessel forming part of a water separator so as to sense when salt water separated from the fuel has reached a pre-determined level. A signal is then sent to indicator means in the form of an electric lamp and buzzer to warn an operator of the marine craft of the need to drain off the collected salt water.

This invention relates to marine craft such as boats or pleasure craft and in particular to a fuel supply system for such a marine craft.

It is well known to provide a marine craft such as a boat, yacht, dingy or jet-ski with an inboard or outboard internal combustion engine using a liquid fuel such as petrol, diesel, paraffin or associated fuels.

Such liquid fuels are stored in a reservoir often known as a fuel tank and are supplied to the engine in order to generate power by combustion.

It is a problem in a marine environment that salt water may seep into the fuel tank thereby contaminating the fuel stored therein. Particular examples include: salt water entering through deck fittings; refueling outlets containing water contaminant; condensation in the vessel tanks; and filling with salt water and/or fresh water by the operator. If water is present in the fuel then damage to the internal combustion engine can occur and damage to parts and components including corrosion of the fuel tank, the fuel supply lines, fuel pumps, pistons and bore of the engine and, if fitted, fuel injectors is also likely to occur.

In addition, the fuel water mixture can be contaminated with a fungal growth that is likely to block or restrict the flow of fuel.

In severe cases hydraulic lock can occur in the engine causing serious damage or in the case of fuel injectors the small components are likely to break.

The failure of such components is potentially a dangerous situation if the vessel is out to sea and a total loss of motive power occurs.

It is an object of this invention to provide a means for detecting the presence of sea water in fuel and indicating the presence to an operator of the vessel.

According to a first aspect of the invention there is provided a marine fuel supply system to supply liquid fuel to an internal combustion engine of a marine craft, the fuel supply system comprising a reservoir to store the liquid fuel, at least one fuel pump to pump fuel from the reservoir to the engine and at least one sensor located between the reservoir and the engine wherein the or each sensor is arranged to detect the presence of sea water in the fuel and provide an indication to an operator of the marine craft.

The presence of sea water may be indicated by an audible warning device.

The audible warning device may be a siren or may be a buzzer.

The presence of sea water may be indicated by a visual warning device.

The visual warning device may be an electric light or light emitting diode.

The indication of the presence of water may be provided to more than one location on the marine craft.

The or each sensor may be located between an outlet from the reservoir and an inlet to a fuel pump.

The fuel supply system may further comprise of a fuel filter located between the fuel pump and the engine.

The system may have a low pressure fuel pump connected to the reservoir and a high pressure fuel pump connected to the low pressure fuel pump to supply fuel at high pressure to the engine and the or each sensor is located between the outlet from the reservoir and the low pressure fuel pump.

The fuel filter may be located between the low pressure fuel pump and the high pressure fuel pump.

The or each sensor may be mounted near to the bottom of a water separator used to separate sea water from the liquid fuel.

The water separator may comprise of a closed vessel having an upper wall, a lower wall, at least one side wall, an inlet to the closed vessel and an outlet from the closed vessel.

The inlet to the closed vessel and the outlet from the closed vessel may be connected to the upper wall of the closed vessel.

There may be at least one baffle plate interposed between the inlet to the closed vessel and the outlet from the closed vessel.

There may be at least one baffle plate extending downwardly from the upper wall into the closed vessel at a position between the inlet to the closed vessel and the outlet from the closed vessel.

There may be a baffle plate extending outwardly from the or one side wall of the closed vessel in close proximity to the outlet from the closed vessel.

An air bleed device may be fitted to the upper wall.

A drain plug may be fitted to the lower wall of the closed vessel.

At least one sensor may be fitted to the or one of the side walls of the closed vessel in close proximity to the lower wall.

At least one sensor may be fitted to the lower wall of the closed vessel.

Preferably, the or each sensor may be located such that when sea water reaches a predetermined level in the closed vessel the indication is provided to the operator.

According to a second aspect of the invention there is provided a marine craft having at least one internal combustion engine and at least one fuel supply system in accordance with the first aspect of the invention.

The fuel supply system may be arranged to supply an indication of the presence of sea water in the fuel to at least two separate craft control stations.

One of the control stations may be a flying bridge.

The craft may have two control stations and the other control station may be a main deck control station.

According to a third aspect of the invention there is provided a water separator for use in a marine fuel supply system to separate sea water from fuel comprising a closed vessel having an upper wall, a lower wall, at least one side wall, an inlet to the closed vessel and an outlet from the closed vessel.

The inlet and the outlet may be connected to the upper wall of the closed vessel.

There may be at least one baffle plate interposed between the inlet and the outlet.

There may be at least one baffle plate extending downwardly from the upper wall into the closed vessel at a position between the inlet to the closed vessel and the outlet from the closed vessel.

There may be a baffle plate extending outwardly from the or one side wall of the closed vessel in close proximity to the outlet from the closed vessel.

An air bleed device may be fitted to the upper wall.

A drain plug may be fitted to the lower wall of the closed vessel.

At least one sensor may be fitted to the or one of the side walls of the closed vessel in close proximity to the lower wall to detect the presence of sea water in the closed vessel.

At least one sensor may be fitted to the lower wall of the closed vessel to detect the presence of sea water in the closed vessel.

Preferably, the or each sensor may be located such that when sea water reaches a pre-determined level in the closed vessel an indication of the presence of sea water is provided.

The invention will now be described by way of example with reference to the accompanying drawing of which:—

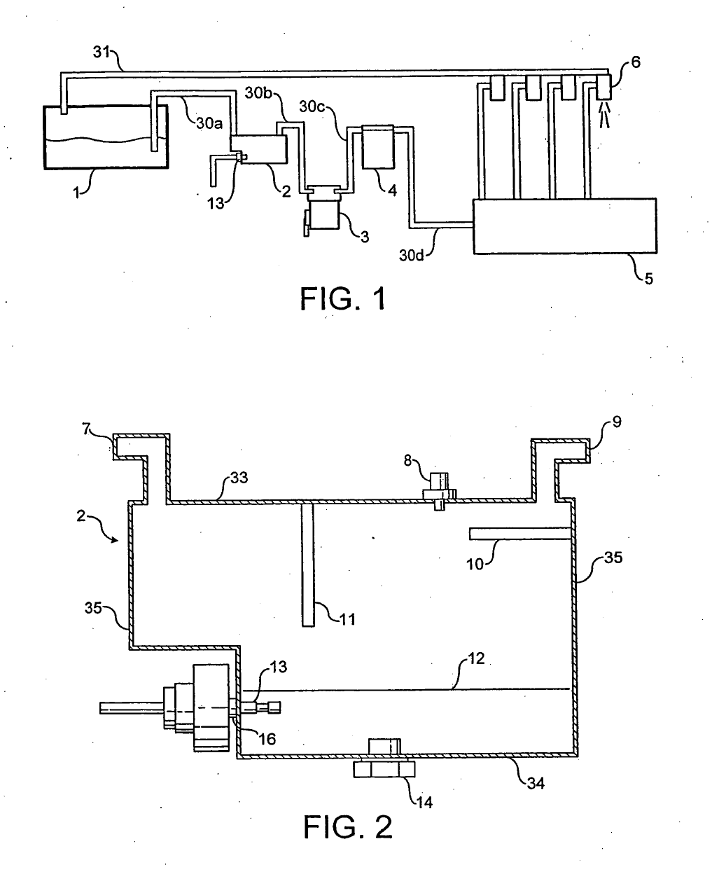

FIG. 1 is a schematic drawing of a marine fuel supply system according to a first aspect of the invention;

FIG. 2 is a cross-section through a water separator forming part of the fuel supply system shown in FIG. 1;

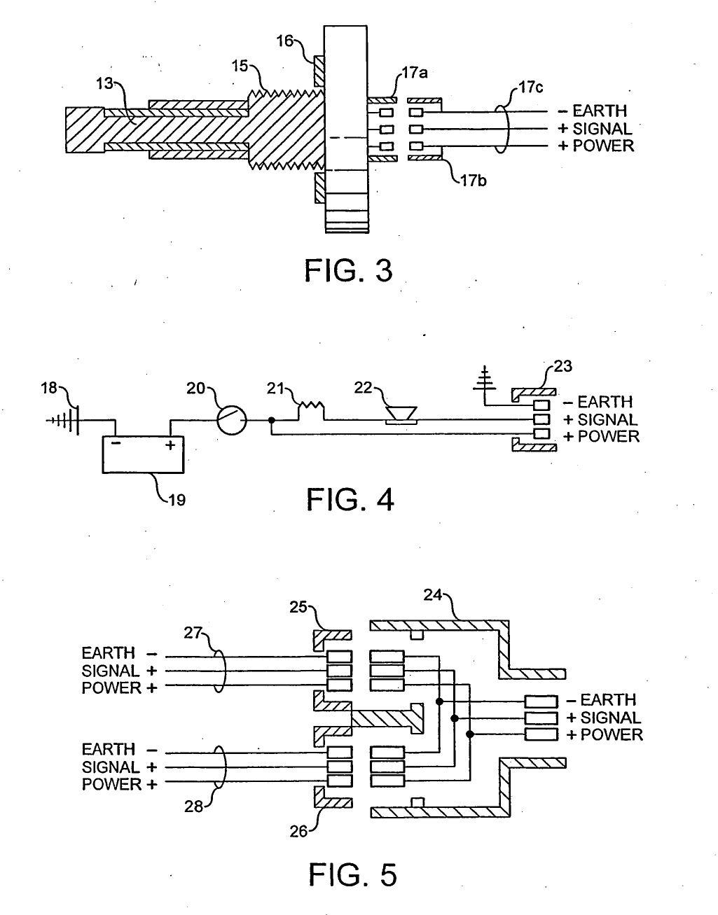

FIG. 3 is an enlarged view of a water sensor forming part of the water separator shown in FIG. 2;

FIG. 4 is a circuit diagram of a warning circuit connected to the water sensor shown in FIG. 3; and

FIG. 5 is a dual connector for connecting the water sensor shown in FIG. 3 to two separate locations.

With reference to FIG. 1 there is shown a marine fuel supply system to supply liquid fuel to an internal combustion engine fitted to a marine craft. The fuel supply system comprises of a reservoir or fuel tank 1 to store the liquid fuel, a pair of fuel pumps 3, 5 to pump fuel from the reservoir 1 to the engine and a sensor 13 located between the reservoir 1 and the engine. The sensor 13 is arranged to detect the presence of sea water in the fuel and provide an indication to an operator of the marine craft.

The water sensor 13 is located between an outlet from the reservoir 1 and an inlet to a low pressure fuel pump 3.

A fuel filter 4 is located between the fuel pump 3 and the engine and as applied to a diesel engine fuel supply system there is the low pressure fuel pump 3 connected to the reservoir 1 and a high pressure fuel pump in the form of a diesel distribution pump is connected to the low pressure fuel pump 3 to supply fuel at high pressure to the engine by means of a number of fuel injectors 6 four of which are shown. The water sensor 13 is located between the reservoir 1 and the low pressure fuel pump 3 and the fuel filter 4 is located between the low pressure fuel pump 3 and the high pressure fuel pump 5.

It will be appreciated that all of the components in the fuel supply line are interconnected by a fuel supply line 30a, 30b, 30c, 30d and that unused fuel is returned to the reservoir 1 via a fuel return line 31.

As best seen with reference to FIG. 2 the sensor 13 is mounted near to the bottom of a water separator 2 used to separate sea water from the liquid fuel. The water separator 2 comprises of a closed vessel in the form of a rectangular tank having an upper wall 33 (e.g. of width 14 cm), a lower wall 34, four side walls 35 (e.g. of height 10 cm), an inlet 7 to the closed vessel and an outlet 9 from the closed vessel. The inlet 7 and the outlet 9 are connected to the upper wall 33 of the closed vessel.

Although the closed vessel is shown as a rectangular tank it will appreciated that it could be of another shape such as for example a cylinder closed of at each end by walls in the form of upper and lower end plates.

There are two baffle plates 10, 11 interposed between the inlet 7 and the outlet 9. In other embodiments the location of the baffle plates is varied such as embodiments in which the position of the second baffle plate 11 is as shown in FIG. 2, and the first baffle plate 10 is similarly upper wall mounted parallel to the second baffle plate 11. In still further embodiments the baffle plates 10, 11 are omitted, although their presence is preferred.

A first baffle plate 11 extends downwardly from the upper wall 33 into the closed vessel at a position between the inlet 7 to the closed vessel and the outlet 9 from the closed vessel. A second baffle plate 10 extends outwardly from one side wall 35 of the closed vessel in close proximity to the outlet 9 from the closed vessel.

The first and second baffle plates 11 and 10 prevent fuel from passing directly from the inlet 7 to the outlet 9 and in particular ensure that any salt water mixed with the fuel has time to settle to the bottom of the closed vessel.

The level of salt water trapped in the closed vessel is indicated by the line 12 on FIG. 2 which it will be noted is just above the level of the sensor 13. This level corresponds to a pre-determined level in the closed vessel at which an indication will be provided by the water sensor 13 to an operator of the marine craft that the level of collected salt water has reached a level where draining of the salt water from the water separator 2 is required.

Although as shown the level is well above the water sensor 13 in practice as soon as the water sensor 13 is totally immersed in salt water an indication will be provided.

An air bleed device in the form of an air bleed screw 8 is fitted to the upper wall 33 to allow any air that gathers in the water separator 2 to be let out.

A drain plug 14 is fitted to the lower wall 34 of the closed vessel to permit salt water collected by the water separator 2 to be drained off.

It will be noted that the sensor 13 is fitted to one of the side walls 35 of the closed vessel in close proximity to the lower wall 34 (e.g. 1 to 3 cm from lower wall) this is in order to maximise the usable volume of the closed vessel while providing sufficient capacity in the water separator 2 for the storage of salt water so that the water separator 2 does not need to be emptied too often. If the sensor 13 is mounted too high in the water separator 2 there is a risk that some of the salt water extracted from the fuel could be re-absorbed.

It will be appreciated that the sensor 13 could be fitted to the lower wall 34 of the closed vessel and project upwardly therefrom. It will be further appreciated that in either case more than one water sensor could be used if a fail safe system is required.

FIG. 3 shows the water sensor 13 in more detail and it can be seen that the water sensor 13 has a threaded shank 15 which is engaged in a hole in the side wall 35 of the closed vessel and is held in place by a nut (not shown) and that a seal 16 is provided to produce a seal between the water sensor 13 and the respective side wall 35.

The water sensor 13 has an electrical socket 17a formed as an integral part thereof for co-operation with a plug 17b forming part of an indication circuit shown in greater detail in FIG. 4. A cable 17c extends away from the plug 17b and contains three leads, a ‘−ve’ or earth lead, a ‘+ve’ power lead and a ‘+ve’ signal lead. The other end of the cable 17c is terminated in a further plug (not shown) which is identical to the plug 17b and is arranged for connection to a socket 23 having three terminals and forms part of the indication circuit.

As best understood with reference to FIG. 4 the indication circuit comprises of a source of electrical power in the form of a battery 19 having a negative terminal connected to earth by an earth lead 18 and a positive terminal connected to an input side of an ignition or power control switch 20.

One output lead from the ignition switch 20 is connected directly to a power terminal of the socket 23 and a further output lead from the ignition switch 20 is connected to a signal terminal of the socket 23 through two salt water indicator devices 21, 22. The third terminal of the socket 23 is connected to earth.

The salt water indicator devices are used to indicate the presence of salt water in the water separator 2 and comprise of an audible warning device in the form of a siren or buzzer 22 and a visual warning device in the form of a light emitting diode or electric light 21.

If required the indication of the presence of water may be provided to more than one location on the craft and the socket 24 shown in FIG. 5 is intended to replace the socket 23 so as to provide two outputs via the plugs 25, 26.

This enables the fuel supply system to supply an indication of the presence of sea water in the fuel to two separate craft control stations. As shown the plug 25 is intended to be connected via a cable 27 to a flying bridge of the marine craft and the plug 26 is intended to be connected via a cable 28 to a main deck control station.

The main deck control station may be located within a cabin of the marine craft or on a rear deck of the marine craft.

Each of the control stations would be provided with at least one of the two types of indication device and preferably with both.

Operation of the fuel control system is as follows. When the ignition switch is turned on and the engine is running fuel is pumped from the reservoir 1 via the water separator 2 by the low pressure fuel pump or lift pump 3 and then through the filter 4 to the distributor pump 5. The distributor pump 5 increases the pressure of the fuel and supplies it in a pre-determined sequence to the fuel injectors 6.

As the fuel passes through the water separator 2 the speed of flow of the fuel is greatly reduced because of the much greater flow area provided by the closed vessel and the presence of the baffles 10, 11. This allows any salt water mixed in with the fuel to separate out and due to its higher specific gravity settle in the bottom of the closed vessel.

Initially the water separator is full of fuel but eventually, the level of the salt water in the closed vessel will rise to the pre-determined level at which point a circuit is made within the sensor 13 and a signal is sent via the signal lead to the buzzer 22 causing it to produce an audible sound and to the electric lamp 21 causing it to illuminate.

This indicates to an operator of the marine craft that the level of salt water collected by the water separator 2 has reached a level where draining is required.

At the next convenient opportunity the drain plug can then be temporarily removed to drain off the collected salt water.

After draining off the salt water the water separator 2 will once again be full of fuel and the sensor 13 will be immersed in the fuel. Because the fuel has a lower electrical conductivity than salt water it will not cause the sensor 13 to send a signal to the indicator devices.

The process will then repeat with successive cycles of water collection and emptying.

It will be appreciated by a person skilled in the art that the invention is not limited to the specific embodiment described herein and that various modifications or alternatives could be constructed without departing from the scope of the invention.

For example, the invention is equally applicable to marine craft having more than one engine fed from a common fuel tank or to marine craft having more than one fuel tank to feed one or more engines.

Similarly, the invention is not limited to the fuel injection means described herein but is applicable to other forms of fuel metering device and to spark ignited as well as diesel engines.

1. A marine fuel supply system to supply liquid fuel to an internal combustion engine of a marine craft, the fuel supply system comprising a reservoir to store the liquid fuel, at least one fuel pump to pump fuel from the reservoir to the engine and at least one sensor located between the reservoir and the engine wherein the or each sensor is arranged to detect the presence of sea water in the fuel and provide an indication to an operator of the marine craft.

2. A fuel supply system as claimed in claim 1 in which the presence of sea water is indicated by an audible warning device.

3. A fuel supply system as claimed in claim 1 in which the presence of sea water is indicated by a visual warning device.

4. A fuel supply system as claimed in claim 1 in which the indication of the presence of water is provided to more than one location on the marine craft.

5. A fuel supply system as claimed in claim 1 in which the or each sensor is located between an outlet from the reservoir and an inlet to a fuel pump.

6. A fuel supply system as claimed in claim 5 in which the fuel supply system further comprises of a fuel filter located between the fuel pump and the engine.

7. A fuel supply system as claimed in claim 1 in which the system has a low pressure fuel pump connected to an outlet from the reservoir and a high pressure fuel pump connected to the low pressure fuel pump to supply fuel at high pressure to the engine and the or each sensor is located between the outlet from the reservoir and the low pressure fuel pump.

8. A fuel supply system as claimed in claim 7 in which a fuel filter is located between the low pressure fuel pump and the high pressure fuel pump.

9. A fuel supply system as claimed in claim 1 in which the or each sensor is mounted near to the bottom of a water separator used to separate sea water from the liquid fuel.

10. A fuel supply system as claimed in 9 in which the water separator comprises of a closed vessel having an upper wall, a lower wall, at least one side wall, an inlet to the closed vessel and an outlet from the closed vessel.

11. A fuel supply system as claimed in 10 in which the inlet to the closed vessel and the outlet from the closed vessel are connected to the upper wall of the closed vessel.

12. A fuel supply system as claimed in claim 10 in which there is at least one baffle plate interposed between the inlet to the closed vessel and the outlet from the closed vessel.

13. A fuel supply system as claimed in claim 12 in which there is at least one baffle plate extending downwardly from the upper wall into the closed vessel at a position between the inlet to the closed vessel and the outlet from the closed vessel.

14. A fuel supply system as claimed in claim 12 in which there is a baffle plate extending outwardly from the or one side wall of the closed vessel in close proximity to the outlet from the closed vessel.

15. A fuel supply system as claimed in claim 10 in which an air bleed device is fitted to the upper wall.

16. A fuel supply system as claimed in claim 10 in which a drain plug is fitted to the lower wall of the closed vessel.

17. A fuel supply system as claimed in claim 10 in which at least one sensor is fitted to the or one of the side walls of the closed vessel in close proximity to the lower wall.

18. A fuel supply system as claimed in claim 10 in which at least one sensor is fitted to the lower wall of the closed vessel.

19. A fuel supply system as claimed in claim 17 in which the or each sensor is located such that when sea water reaches a predetermined level in the closed vessel the indication is provided to the operator.

20. A marine craft having at least one internal combustion engine and at least one fuel supply system as claimed in claim 1.

21. A marine craft as claimed in claim 20 in which the fuel supply system is arranged to supply an indication of the presence of sea water in the fuel to at least two separate craft control stations.

22. A marine craft as claimed in claim 21 in which one of the control stations is a flying bridge.

23. A marine craft as claimed in claim 22 in which the craft has two control stations and the other control station is a main deck control station.

24. (canceled)

25. (canceled)

26. A water separator for use in a marine fuel supply system to separate sea water from fuel comprising a closed vessel having an upper wall, a lower wall, at least one side wall, an inlet to the closed vessel and an outlet from the closed vessel.

27. (canceled)
